(19) United States
(12) Patent Application Publication
(10) Pub. No.: US 2015/0031341 A1
(43) Pub. Date: Jan. 29, 2015

(54) METHOD FOR RESPONDING TO PUSH NOTIFICATION BASED COMMUNICATION REQUEST

(71) Applicant: VONAGE NETWORK LLC, HOLMDEL, NJ (US)

(72) Inventors: Guy BAR ON, Tel-Aviv (IL); Boaz ZEHAVI, Jersey City, NJ (US); Gil OSHER, Tel-Aviv (IL); Dany ORR, Tel-Aviv (IL)

(21) Appl. No.: 13/952,967

(22) Filed: Jul. 29, 2013

(51) Int. Cl. H04M 3/42; H04W 4/16

(52) U.S. Cl. CPC H04M 3/42195; H04W 4/16
USPC 455/414.1

(57) ABSTRACT

A method for responding to a push notification after a missed call between a calling party and a called party's mobile device is disclosed. The method includes sending a push notification request directed to the called party's mobile device indicative of a communication. The method then detects that the communication request has failed and enables a dial-back operation to the calling party.

### BACKGROUND OF THE INVENTION

The invention relates to Voice over Internet Protocol (VoIP) communications, and more specifically to methods and apparatus used to dial-back a missed call in a VoIP communications session with a mobile device.

Many mobile communications and computing devices are now configured to load and run application programs that can provide virtually any sort of functionality. As many of these mobile communications and computing devices are able to establish a link to the Internet, either via a wireless router or via a data channel of a cellular communication network, it is possible for an application running on a mobile device to communicate via the Internet. Examples of such mobile communications and computing devices include the Apple iPhone™ and various mobile phones that utilize the Android™ operating system.

Various service providers have created communications applications that can be loaded and run on a mobile communications device such as the Apple iPhone™. Some communications applications provide functionality that allows a VoIP service provider to establish a VoIP communications channel with a mobile communications device via an Internet connection or a cellular data connection that is maintained by the mobile communications device. When a mobile communications device is running one of these communications applications, it is possible for a VoIP service provider to establish a VoIP telephone call between the mobile communications device and a third party.

Many mobile communications devices are configured to run only one or two applications simultaneously in the foreground. In some instances, the communications application is not running on the mobile communications device. In other instances, the communications application is in the background, and it cannot be reactivated by a wake up command from an external device. In these instances, the IP telephony system cannot communicate with the communications software application, and therefore cannot establish a new IP telephone call to the called party's mobile device. This condition can be problematic if one is attempting to establish a VoIP communications channel with a mobile communications device if the communications application that provides the functionality for establishing a VoIP communications channel is not actually running on a mobile device. Although, many users are willing to download and install a service provider's communications application, once the communications application is installed, it is not usually running in the foreground on the user's mobile device. Generally, either some other application is running, or no applications are actively running. Accordingly, when a calling party attempts to establish a VoIP telephone call to a called party's mobile communications device via a VoIP service provider, it is difficult for the VoIP service provider to complete the telephone call to the called party's mobile device.

Even when an application is actively running on a mobile device, it may be advantageous to delegate reception of incoming communications attempts to a general-purpose notification service. For example, a VoIP application installed on a mobile device may use industry standard SIP protocol, via UDP transport, to establish and maintain telephone calls. However, keeping a communications path constantly open for incoming calls requires frequent exchanges of information between the VoIP service provider and the mobile device that can unacceptably reduce battery life.

While there are techniques to reduce the frequency of information exchanges, such as using the TCP transport method rather than UDP, these techniques also have drawbacks. TCP is less well-adopted in the industry, and/or it may be more prone to lost calls whenever the mobile device switches connection methods or is otherwise assigned a new IP address.

In the examples that follow, the signaling between various elements used to establish a VoIP communications channel with a mobile device generally follows the Session Initiation Protocol (SIP) format. Session Initiation Protocol (SIP) is a signaling protocol for initiating, managing and terminating media (e.g., voice, data and video) sessions across packet based networks that typically use the Internet Protocol (IP), of which VoIP is an example.

The Apple Push Notification Service (APNS) allows an application that is installed on an Apple device such as the Apple iPhone™ to complete a registration process that results in the application receiving a device token. The device token uniquely identifies the mobile device. The application on the mobile device then provides this token to the service provider that created the application on the mobile device.

Once the service provider has possession of the token associated with a mobile device, the service provider can cause the APNS to send push notifications to the mobile device. A request for a push notification that is sent from the service provider to the APNS would include the device token, and information about the type of push notification that is to be sent to the mobile device.

When the APNS receives a push notification request from a service provider, it uses the information in the request to create a formatted push notification that it then delivers to the mobile device. The push notification can cause the mobile device to take several different actions. For example, a push notification can cause the mobile device to update a number displayed on a badge associated with the service provider's application. The number usually indicates that new information is available to the application, and the number may indicate the quantity of the new information. When a user sees a number on an application badge, the user can press the badge to load and run the application, which usually results in the application requesting and obtaining the new information that is waiting.

A push notification can also cause a notification message to be displayed on the mobile device. The notification message will usually include two buttons that the user can press. One button, usually labeled as “DISMISS,” allows the user to dismiss the notification message. If the user presses this button, the notification message will no longer be displayed, and no further action will be taken by the mobile device. If the user pushes the other button, which is usually labeled as “VIEW,” the mobile device will load and run the application on the mobile device that is associated with the service provider that caused the push notification to be sent. In other configurations, when a push notification is received by a mobile device, the mobile device simply automatically loads and runs a particular application associated with the push notification, without waiting for user intervention.

By using a push notification service, the VoIP application installed on a mobile device can benefit from a common channel and provide options for handling calls based on the notification. However, the push notification service may be limited in the event the calling party terminates the call before the called party has the opportunity to take any action. The called party may receive the push notification but is unable to respond and misses the call. Thus, what is needed is a method to dial-back a calling party after a called party misses the call.

### SUMMARY OF THE INVENTION

A method for responding to a push notification after a missed call between a calling party and a called party's mobile device is disclosed. The method includes sending a push notification request directed to the called party's mobile device indicative of a communication request. The method then detects that the communication request has failed and enables a dial-back operation to the calling party.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a diagram illustrating elements of a system that interconnects user mobile devices with a push notification service and a VOIP service provider;

FIG. 2 is a diagram illustrating the message signaling that occurs when a new VOIP telephone call is established between a calling party and a called party's mobile communications device;

FIG. 3 a diagram of various elements of a processor which can be part of a VOIP telephony system; and

FIG. 4 is a diagram illustrating steps of a method of connecting a missed call in accordance with the present invention performed by elements of a VoIP service provider.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION OF THE INVENTION

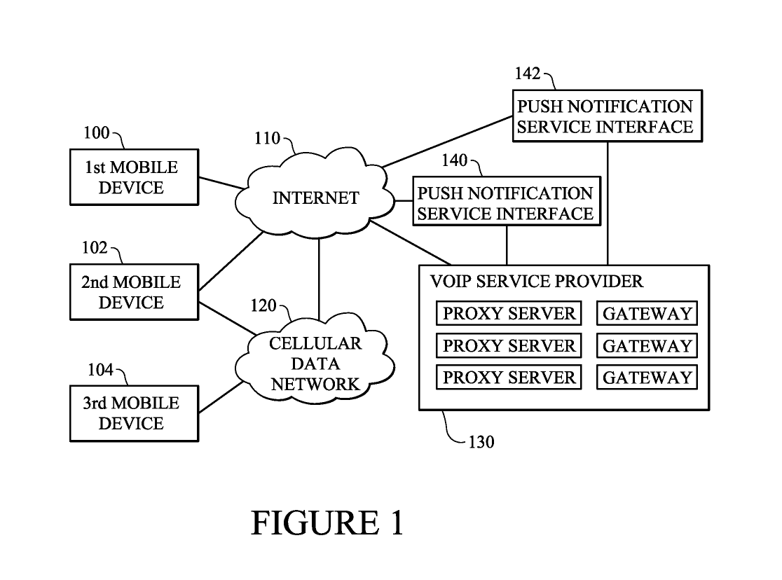

Methods for establishing a VoIP communications channel with a mobile communications device are described in connection with FIGS. 1-4. These methods make it possible to establish a VoIP communications channel with a mobile communications device even when the mobile device is not already running a communications application from a VoIP service provider.

The methods described herein make use of a push notification service that sends messages to mobile communications devices. For example, Apple provides the Apple Push Notification Service (APNS), which is presently designed to send messages to at least the Apple iPhone™, the Apple iPad™ and the Apple iTouch™ devices. The push notifications are rigidly formatted messages that can be received by such devices anytime they are running and connected to either the Internet or a cellular data network.

Although the following description uses the APNS as an example, use of the APNS is not required, nor should this example be considered limiting. Other push notification services that have different message formats and different capabilities could also be used.

Also, as introduced above, the signaling between various elements used to establish a VoIP communications channel with a mobile device generally follows the SIP format. The details and functionality of SIP can be found in the Internet Engineering Task Force (IETF) Request for Comments (RFC) Paper No. 3261 entitled, “SIP: Session Initiation Protocol” herein incorporated in its entirety by reference. SIP establishes and negotiates a session, including the modification or termination of a session. It uses a location-independent address system feature in which called parties can be reached based on a party's name. SIP supports name mapping and redirection, allowing users to initiate and receive communications from any location. As such, it presents part of a solution to the problem of establishing a communications channel with a mobile telephony device, as described below.

Methods of establishing a VoIP communications channel with a mobile device could also use signaling formats other than SIP. Thus, the description of typical SIP signaling should not be considered limiting.

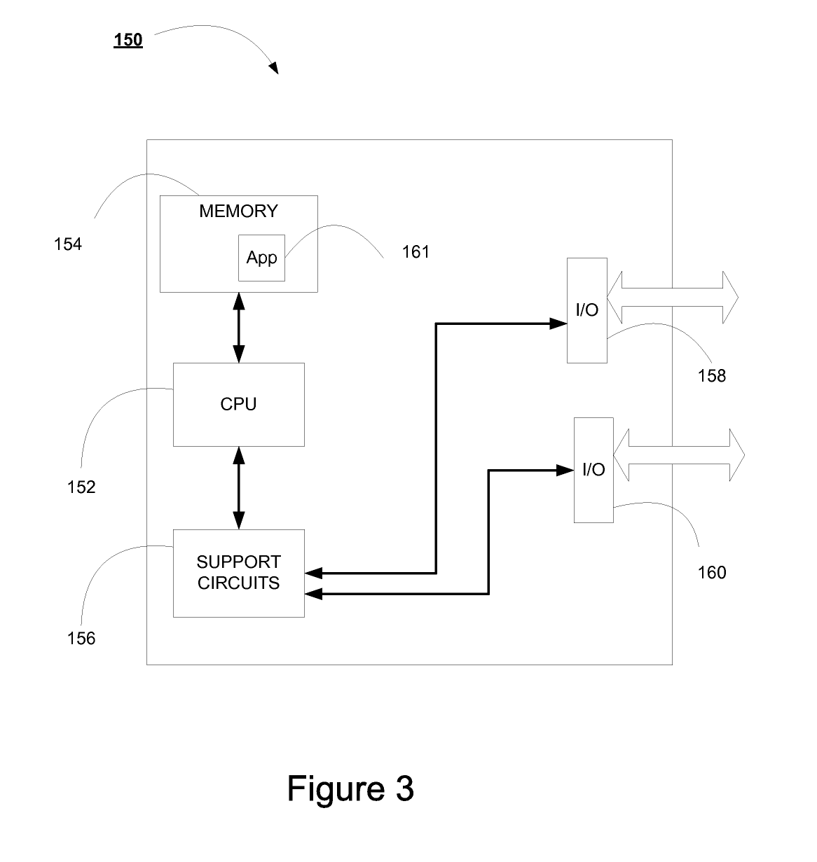

The following description provides for integration of a push notification service and VoIP system architecture to help establish a VOIP communications channel with a mobile device. FIG. 1 illustrates the general architecture of systems that communicate with mobile devices. As shown therein, first, second and third mobile devices 100, 102, 104 are part of the architecture. The mobile devices can be any mobile communications and computing devices that are capable of loading and running a communications application 161 (see FIG. 3) that allows a mobile device to establish a VoIP communications channel. The first mobile device 100 has a data connection to the Internet 110. This data connection could be a wired or wireless connection to the Internet. For example, the first mobile device could establish a wireless connection to the Internet 110 via a wireless router (not shown). The second mobile device 102 has a direct connection to the Internet 110, and a connection to a cellular data network 120 via a cellular link. The direct connection to the Internet 110 could be via wired or wireless means. The connection to the cellular data network 120 would typically be established via a cellular transceiver in the second mobile device 102. The third mobile device 104 has only a connection to the cellular data network 120, which would typically be established via a cellular transceiver in the third mobile device 104. However, the cellular data link is used to access the Internet 110.

The architecture also includes two push notification service interfaces 140 and 142. The push notification service interfaces could be two separate instantiations of the Apple Push Notification Service that are maintained on separate hardware located in different locations. Alternatively, the push notification service interfaces could be some other type of push notification service designed to send push notifications to other types of mobile devices.

The push notification service interfaces 140, 142 are both coupled to the Internet 110, which allows the push notification service interfaces to send push notifications to the mobile devices 100, 102, 104. The push notifications could be sent to the first and second mobile devices 100, 102 via the Internet 100. The push notifications could also be sent to the second and third mobile devices 102, 104 via a path that includes the Internet 110 and the cellular data network 120.

The architecture further includes a VoIP service provider 130. The VoIP service provider maintains and controls multiple proxy servers and multiple gateways, as is well known to those of ordinary skill in the VoIP telephony arts.

The VoIP service provider 130 can create a communications application 161 that is loaded onto the mobile devices 100, 102, 104. As described above, a communications application 161 on a mobile device can complete a registration process that results in a device token being issued to the communications application 161. And the communications application can then send a copy of the device token to the VoIP service provider 130. The VoIP service provider then uses this device token in communications with the push notification service interfaces 140, 142 to request that push notifications be sent to the mobile device.

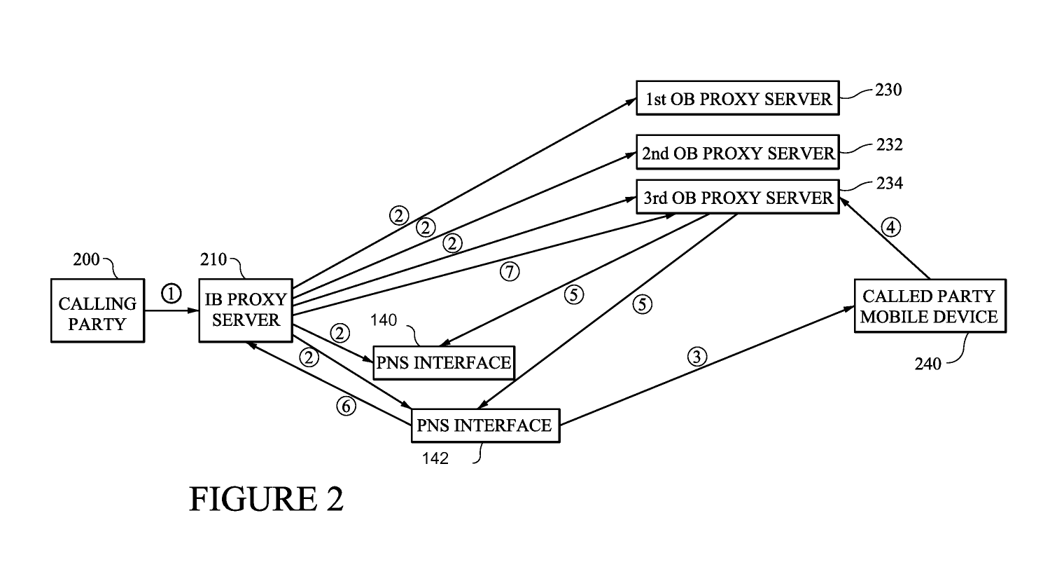

A method of establishing a VoIP communications channel to a mobile device that has loaded a communications application 161 from a VoIP service provider will now be described in conjunction with the diagram in FIG. 2. This method assumes that: (1) the communications application 161 on the mobile device has already obtained a device token and forwarded that device token to the VOIP service provider; and (2) that the communications application 161 is not already running on the mobile device.

The method is initiated when a calling party 200 seeks to establish a VOIP telephone call to a called party's mobile device 240. This could occur when the calling party dials the called party's telephone number. However, this could also occur under a variety of other circumstances. For example, the calling party 200 might be using a communications application 161 on his own mobile device, and the calling party 200 might utilize the communications application 161 to request that a VoIP telephone call be placed to the called party 240.

For purposes of the following explanation, the way in which the call is initiated is not important. All that matters is that the calling party 200 is seeking to establish a VoIP telephone call to the called party's mobile device via a VoIP service provider.

The VoIP service provider would, in some fashion, control and/or interact with multiple proxy servers 210, 230, 232 and 234. A first proxy server 210 will be referred to as the inbound proxy server because the request to establish a VoIP telephone call to the called party's mobile device 240 is first received at this proxy server. The other proxy servers 230, 232, 234 illustrated in FIG. 2 will be referred to as outbound proxy servers because these proxy servers are the ones capable of making contact with and registering the called party's mobile device 240.

FIG. 2 also illustrates multiple push notification service interfaces 140, 142. As explained above, these push notification service interfaces 220, 222 are capable of sending push notifications to the called party's mobile device 240 in response to requests from service providers. Each push notification service interface could be a separate instantiation of the push notification service running on a separate set of hardware, where different instantiations are at different physical locations. In many instances, the push notification service interfaces will be operated by an entity other than the VoIP service provider.

The method begins when the calling party 200 sends a request to establish a VoIP telephone call to the called party's mobile device 240. This request would be received by the inbound proxy server 210. This request corresponds to the arrow labeled with reference number 1.

In accordance with SIP signaling in one embodiment of the invention, the inbound proxy server 210 sends an INVITE message to one or more outbound proxy servers 230, 232, 234 associated with the called party's mobile device 240, as indicated by the arrows labeled with reference number 2. However, because the communications application 161 on the called party's mobile device 240 is not running, the called party's mobile device will not be registered with any of the outbound proxy servers 230, 232, 234. Another scenario where a server of the VoIP service provider 130 may be unable to communicate with a communications application 161 on a user's telephony device occurs when the communications application 161 has been moved to the background of an operating system on the user's telephony device. While in the background, the communications application is unable to send regular keep-alive messages to a server of an VoIP service provider 130. For this reason, each of the outbound proxy servers 230, 232, 234 will send a message back to the inbound proxy server 210 indicating that the called party cannot be found.

At the same time the inbound proxy server 210 sends INVITE messages to the outbound proxy servers 230, 232, 234, the inbound proxy server 210 will also send a request to the push notification service interfaces 220, 222 associated with the called party's mobile device to request that a push notification be sent to the called party's mobile device 240. The request may include information identifying the calling party by name, telephone number, or via other identifying means. In some instances, the request that a push notification be sent may take the same form as the SIP INVITE message sent to the outbound proxy servers. The requests sent to the push notification service interfaces 220, 222 are also indicated by arrows labeled with reference number 2.

In FIG. 2, the second push notification service interface 222 is linked to the called party's mobile device 240. When the second push notification service interface 222 receives the request to send a push notification, it generates and forwards a suitable push notification to the called party's mobile device 240. This signaling is represented with the arrow identified with reference number 3.

When the called party's mobile device 240 receives the push notification, it will display a message to the called party that indicates there is an incoming telephone call. The message may include DISMISS and VIEW buttons that can be activated by the called party.

When the communications application 161 is activated, the communications application 161 may receive some of the information contained within the push notification. For example, the information may include the fact that the communications application 161 has been activated in response to a push notification. The information may also include the identity of the push notification service interface that sent the push notification. Further, information about the incoming call, such as the telephone number or identity of the calling party, may be provided to the communications application 161.

When the communications application 161 is activated, the communications application 161 may receive some of the information contained within the push notification. For example, the information may include the fact that the communications application 161 has been activated in response to a push notification. The information may also include the identity of the push notification service interface that sent the push notification. Further, information about the incoming call, such as the telephone number or identity of the calling party, may be provided to the communications application 161. The communications application 161 then contacts one of the outbound proxy servers to register itself. FIG. 2 shows the called party's mobile device 240 contacting the third outbound proxy server 234. This signaling is represented by the arrow identified with reference number 4.

The registration request sent from the called party's mobile device 240 to the third outbound proxy server 234 may be a typical SIP REGISTER message, followed by a special SIP NOTIFY message. When the third outbound proxy server 234 receives these messages from the called party's mobile device 240, it will send a message to one or all of the push notification service interfaces 140, 142 associated with the called party's mobile device. It is the NOTIFY message which causes this to occur. In alternate embodiments, some other type of signaling or a special type of registration request may trigger the outbound proxy server 234 to send such a message to one or more of the push notification service interfaces 140, 142. This messaging is represented by the arrows identified with reference number 5 in FIG. 2.

The initial registration request sent from the communications application to the outbound proxy server may include information about which push notification service interface originally sent the push notification to the mobile device. In alternate embodiments, information exchanged between the mobile device and the outbound proxy server after the initial registration request may include this information. When provided, it would allow the outbound proxy server to send a message directly to the push notification service interface that sent the push notification to the mobile device.

FIG. 3 illustrates elements of a computer processor that can be used as part of a mobile device to accomplish various functions associated with the present invention. The mobile device processing unit 150 along with their operating components and programming carry out specific or dedicated portions of the functions performed by the mobile device in a VoIP based telephony service.

The processing unit 150 shown in FIG. 3 may be one of any form of a general purpose computer processor used in accessing an IP-based network, such as a corporate intranet, the Internet or the like. The processor 150 comprises a central processing unit (CPU) 152, a memory 154, and support circuits 156 for the CPU 152. The processing unit 150 also includes provisions 158/160 for connecting the processing unit 150 to possibly one or more input/output devices (not shown) for accessing the processor and/or performing ancillary or administrative functions related thereto.

The memory 154 is coupled to the CPU 152. The memory 154, or computer-readable medium, may be one or more of readily available memory such as random access memory (RAM), read only memory (ROM), floppy disk, hard disk, flash memory or any other form of digital storage, including but not limited to non-volatile memory, local or remote. The support circuits 156 are coupled to the CPU 152 for supporting the processor in a conventional manner. These circuits include cache, power supplies, clock circuits, input/output circuitry and subsystems, and the like.

Communications application 161, when executed by the CPU 152, causes the processing unit 150 to perform processes of the disclosed embodiments, and are generally stored in the memory 154. The communications application 161 may also be stored and/or executed by a second CPU (not shown) that is remotely located from the hardware being controlled by the CPU 152. Also, the communications application 161 could also be stored remotely from the CPU. For example, the software could be resident on servers and memory devices that are located remotely from the CPU, but which are accessible to the CPU via a data network connection.

The communications application 161, when executed by the CPU 152, transforms the general purpose computer into a specific purpose computer that performs one or more functions of the VoIP telephony service 120. Although the processes of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The communications application 161 of the disclosed embodiments are capable of being executed on any computer operating system, and are capable of being performed using any CPU architecture.

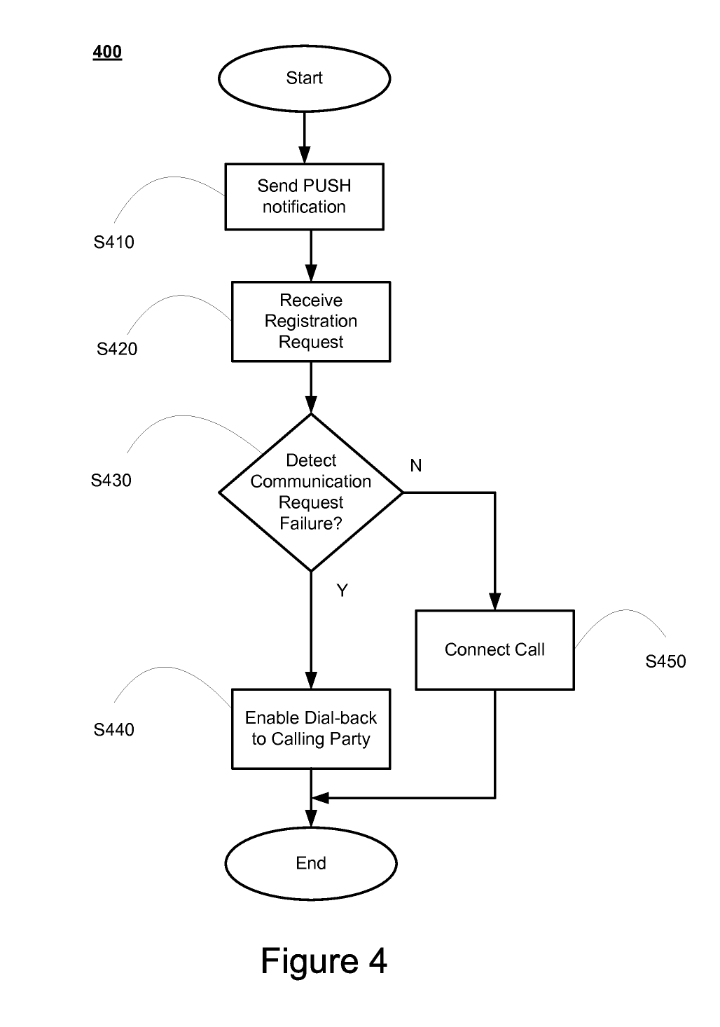

FIG. 4 illustrates steps of a method 400 of connecting a missed call performed by elements of a VoIP service provider. The steps of this method correspond to some of the aspects and elements described above in connection with FIGS. 1 and 2.

The method begins in step S410, where VoIP service provider 130 sends a push notification message to called party's mobile device 240 to activate communications application 161 on called party's mobile device 240 in response to a call setup request from calling party 200. This message could include text for the message to be displayed on the called party's mobile device 240 as part of the push notification. Further, the notification message may provide an indication regarding the identity of the calling party 200. This information would be provided by the inbound proxy server 210 as part of the request for a push notification from calling party 200. The push notification service interface 222 would use the information provided by the inbound proxy server 210 to format a push notification to called party's mobile device 240 that will cause the relevant information to appear on the called party's mobile device 240.

At step 420, the push notification causes communications application 161 to provide the “VIEW” option to be selected on called party's mobile device 240. An element of VoIP service provider 130 (i.e. one of the outbound proxy servers operated or used by the VoIP service provider 130) then receives a registration request from called party's mobile device 240.

The method continues to step S430, when the IP service provider 130 detects whether or not the communication request has failed. One of the outbound proxy servers 230, 232 or 234 sends a message to the push notification service interfaces 140 and 142 associated with the calling party 200 and which sent the original push notification to the called party's mobile device 240. If the communication request has not failed, the outbound and inbound servers complete the communication request and the call is connected normally at step S450.

However, in a scenario associated with the subject invention, the communication request has already been terminated and the IP service provider 130 detects the communication request has failed (e.g. calling party 200 terminates the call, as such, the VoIP call is not established). In the event that the called party on called party's mobile device 240 fails to accept a call from calling party 200, the push notification will time-out. IP service provider 130 will detect that the call has terminated through the timed-out push notification. If the calling party 200 disconnects the call before the called party on called party's mobile device 240 accepts the call, a BYE indication will be sent in the SIP message and IP service provider 130 will detect that the call has terminated through the SIP message. In either case, a notification message “MISSED CALL” may be displayed on called party's mobile device 240. The notification message sent to called party's mobile device 240 of the “MISSED CALL” indicates that a communication request had been attempted by calling party 200 but the call was not established. In addition the notification for the call itself is present on a notification message bar of the called party's mobile device 240.

The method continues to step S440, when the communication application 161 on called party's mobile device 240 is enabled to call calling party 200. VoIP service provider 130 sends identification information associated with the calling party 200 in the push notification which enables communication application 161 to provide a dial-back operation on called party's mobile device 240. The VoIP service provider 130 receives a communication request from called party's mobile device 240 to calling party's mobile device 200 through the dial-back operation.

In one embodiment, the VoIP service provider 130 sends the push notification to called party's mobile device 240 causing communication application 161 to provide a notification message to suggest a manual dial-back. The notification message may be an audio message or it may display a message suggesting the dial-back operation. The notification message may provide an indication regarding the identity of the calling party.

In another embodiment, the VoIP service provider 130 sends the push notification to called party's mobile device 240 causing communication application 161 to provide an automatic dial-back operation to the calling party. The VoIP service provider 130 may detect that the mobile device is in an active state suggesting that the called party is now available for the call. The active state refers to the device being available or activated and may be online or connected to a data network. In the active state the called party's device 240 is available to be recognized by VoIP service provider 130. Once available in this active state, the VoIP service provider 130 enables communication application 161 to automatically execute the dial-back operation for the missed call. The communication application 161 may notify the called party first to allow the called party the opportunity to override the application without dialing the call.

In another embodiment, the VoIP service provider 130 may enable communication application 161 to automatically play a message, such as a message for example, left by the calling party. The called party may miss the call due to being on another call, being away from the mobile device, or other reasons. The VoIP service provider 130 may again detect that the mobile device is in an active state suggesting that the called party is now available for the call. The VoIP service provider may store the message left by the calling party when the called party is available and delivered to communication application 161 which will play the message to the called party. The message may be preceded by a notification of the missed call. In addition, the message may be an audio message, a video message, a text message or an automated message stored on VoIP service provider 130.

In another embodiment, the VoIP service provider 130 causes communication application 161 to provide a reminder for a dial-back operation at a later time. The called party may be occupied for some time and would prefer the dial-back operation be performed at a later more convenient time.

In another embodiment, VoIP service provider 130 causes communication application 161 to provide an automatic message to the calling party's mobile device 200 that the call has been received and the call will be returned at a later time.

In another embodiment, the VoIP service provider 130 enables communication application 161 to provide a dial-back operation feature to initiate a call to the calling party upon receiving the voicemail message.

The forgoing description made reference to certain standard SIP messaging. In alternate embodiments, different types of messaging could be used to establish a VoIP telephone call between a calling party and a called party's mobile device. SIP signaling is merely one way in which it could occur.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A method for responding to a push notification after a missed call between a calling party and a called party's mobile device, comprising:
sending a push notification request directed to the called party's mobile device indicative of a communication request;
detecting that the communication request has failed; and
enabling a dial-back operation directed to the calling party.

2. The method of claim 1, further comprising receiving a registration request originating from the called party's mobile device.

3. The method of claim 1, wherein the push notification request comprises an identity of the calling party.

4. The method of claim 3, wherein the identity of the calling party includes a telephone number associated with the calling party.

5. The method of claim 3, wherein the identity of the calling party includes a name associated with the calling party.

6. The method of claim 1, wherein the enabling step comprises providing a notification message suggesting a manual dial-back operation directed to the calling party.

7. The method of claim 1, wherein the enabling step comprises providing an automatic dial-back operation directed to the calling party.

8. The method of claim 1, wherein the enabling step comprises transmitting a message originating from the called party and providing a dial-back operation option.

9. The method of claim 8, wherein the message comprises an audio message, a video message, a text message or an automated message.

10. The method of claim 9, wherein the enabling step occurs in response to detecting that the called party's mobile device is in an active state.
